(19) United States
(12) Patent Application Publication
(10) Pub. No.: US 2026/0204457 A1
(43) Pub. Date: Jul. 16, 2026

(54) CABLE

(71) Applicant: SUMITOMO ELECTRIC INDUSTRIES, LTD., Osaka (JP)

(72) Inventors: Atsuko SHINOMIYA, Tochigi (JP); Jo YAGISAWA, Tochigi (JP); Takaya KOHORI, Tochigi (JP); Jun OTSUKA, Tochigi (JP); Taro FUJITA, Osaka (JP); Shigeyuki TANAKA, Osaka (JP); Syota MACHINAKA, Osaka (JP)

(21) Appl. No.: 19/417,723

(22) Filed: Dec. 12, 2025

(30) Foreign Application Priority Data
Jan. 10, 2025 (JP) 2025-004388

(51) Int. Cl. H01B 7/18; H01B 3/30; H01B 7/02; H01B 7/22; H01B 7/29; H01B 11/10

(52) U.S. Cl. CPC H01B 7/1875; H01B 3/30; H01B 7/0216; H01B 7/1855; H01B 7/226; H01B 7/292; H01B 11/10

(57) ABSTRACT

A cable includes a twisted pair electric wire in which a pair of electric wires are twisted, an inner sheath disposed outside the twisted pair electric wire, a shield layer disposed outside the inner sheath, and an outer sheath disposed outside the shield layer. A repulsive force when the cable is bent in a U-shape and a radius of curvature of a bent portion of the cable is changed from 100 mm to 50 mm is 0.5 N or less.

### CROSS-REFERENCE TO RELATED APPLICATIONS

This patent application is based on and claims priority to Japanese Patent Application No. 2025-004388 filed on January 10, 2025, the entire contents of which are incorporated herein by reference.

### TECHNICAL FIELD

The present disclosure relates to a cable.

### BACKGROUND

Patent Literature 1 (Japanese Unexamined Patent Application Publication No. 2020-017436) discloses a twisted pair cable including a pair of electric wires twisted together, the electric wires having a plurality of types of twist pitches.

### SUMMARY

A cable of the present disclosure includes a twisted pair electric wire in which a pair of electric wires are twisted, an inner sheath disposed outside the twisted pair electric wire, a shield layer disposed outside the inner sheath, and an outer sheath disposed outside the shield layer. A repulsive force when the cable is bent in a U-shape and a radius of curvature of a bent portion of the cable is changed from 100 mm to 50 mm is 0.5 N or less.

### BRIEF DESCRIPTION OF THE DRAWINGS

FIG. 1 is a cross-sectional view of a cable in a plane perpendicular to a longitudinal direction of the cable according to one aspect of the present disclosure.

FIG. 2A is an illustration of a repulsive force evaluation method.

FIG. 2B is an illustration of the repulsive force evaluation method.

FIG. 3 is an illustration of a pull-out force evaluation method.

FIG. 4 is a table indicating the configuration of cables produced in experimental examples and results of the evaluation.

### DETAILED DESCRIPTION

In recent years, the electrification of various vehicles such as automobiles has been progressing, resulting in an increase in the length of cables installed in the vehicles. The cable needs to be deformed in accordance with the shape of a space in which the cable is installed, and is required to have excellent flexibility from the viewpoint of enhancing workability and productivity during the manufacture of automobiles and the like.

An object of the present disclosure is to provide a cable having excellent flexibility.

Embodiments will be described below.

### Description of Embodiments of Present Disclosure

First, embodiments of the present disclosure will be listed and described. In the following description, the same or corresponding elements are denoted by the same reference numerals, and the same description thereof will not be repeated.

(1) A cable according to one aspect of the present disclosure includes a twisted pair electric wire in which a pair of electric wires are twisted, an inner sheath disposed outside the twisted pair electric wire, a shield layer disposed outside the inner sheath, and an outer sheath disposed outside the shield layer. A repulsive force when the cable is bent in a U-shape and a radius of curvature of a bent portion of the cable is changed from 100 mm to 50 mm is 0.5 N or less.

By setting the repulsive force to 0.5 N or less, the cable is easily deformed and has excellent flexibility, and workability and productivity in performing wiring can be improved.

(2) In the above (1), a tensile modulus of the inner sheath may be larger than a tensile modulus of the outer sheath and smaller than a tensile modulus of an insulator included in the electric wires.

When an external force is applied to the cable, the component far from the center deforms first. Accordingly, by making the tensile modulus smallest in the outer sheath and larger in the inner sheath and the insulator in this order from the center, a cable that is particularly easy to deform and has excellent flexibility can be obtained.

(3) In the above (1) or (2), the inner sheath may contain polypropylene as a main component.

When the inner sheath contains polypropylene as a main component, the heat resistance of the cable can be enhanced, and the electrical characteristics can be enhanced even when heated.

(4) In the above (3), the inner sheath may further contain a thermoplastic elastomer as a main component.

The inner sheath contains the thermoplastic elastomer, and thus the flexibility of the inner sheath and the cable can be enhanced. Therefore, the repulsive force of the cable can be reduced, and the workability during wiring can be improved.

(5) In any one of the above (1) to (4), an insulator included in the electric wires may contain polypropylene as a main component.

When the insulator contains polypropylene as a main component, the heat resistance of the electric wire, the twisted pair electric wire, and the cable can be enhanced, and the electrical characteristics can be enhanced even when heated.

(6) In any one of the above (1) to (5), the shield layer may include a first shield layer including a metal tape, and a second shield layer including a metal wire. A pull-out force between the first shield layer and the second shield layer may be 10 N or more.

Since the cable includes the first shield layer and the second shield layer as the shield layer, it is possible to particularly reduce signal leakage to the outside and radio wave intrusion from the outside. Further, the attenuation amount in the high frequency region of the cable can be reduced.

By setting the pull-out force between the first shield layer and the second shield layer to 10 N or more, the adhesion strength of the shield layers can be increased, thereby preventing damage when force is applied along the longitudinal direction of the cable.

(7) In any one of the above (1) to (6), the cable may further comprise a resin tape layer in which a resin tape is disposed in a spiral shape along a longitudinal direction of the twisted pair electric wire.

When the cable of the present disclosure further has a resin tape layer, the shape of the twisted pair electric wire can be stabilized. Thus, in the cable of the present disclosure, the shapes of the inner sheath, the shield layer, and the outer sheath disposed outside the twisted pair electric wire can be stabilized, and can be easily formed into a desired shape.

### Details of Embodiments of Present Disclosure

Specific examples of a cable according to an embodiment of the present disclosure (hereinafter referred to as "the embodiment") will be described below with reference to the drawings. The present invention is not limited to these examples, but is defined by the scope of the claims, and is intended to include all modifications within the meaning and scope equivalent to the scope of the claims.

In the present specification, the term "first", "second", or the like may be added to the name of a component, such as a first shield layer or a second shield layer. The terms "first", "second", and the like are merely used to identify each component and the like and avoid confusion during the description, and do not represent "arrangement", "priority", and the like. Accordingly, when there is no risk of confusion or when collectively referring to them, they may simply be referred to as a shield layer.

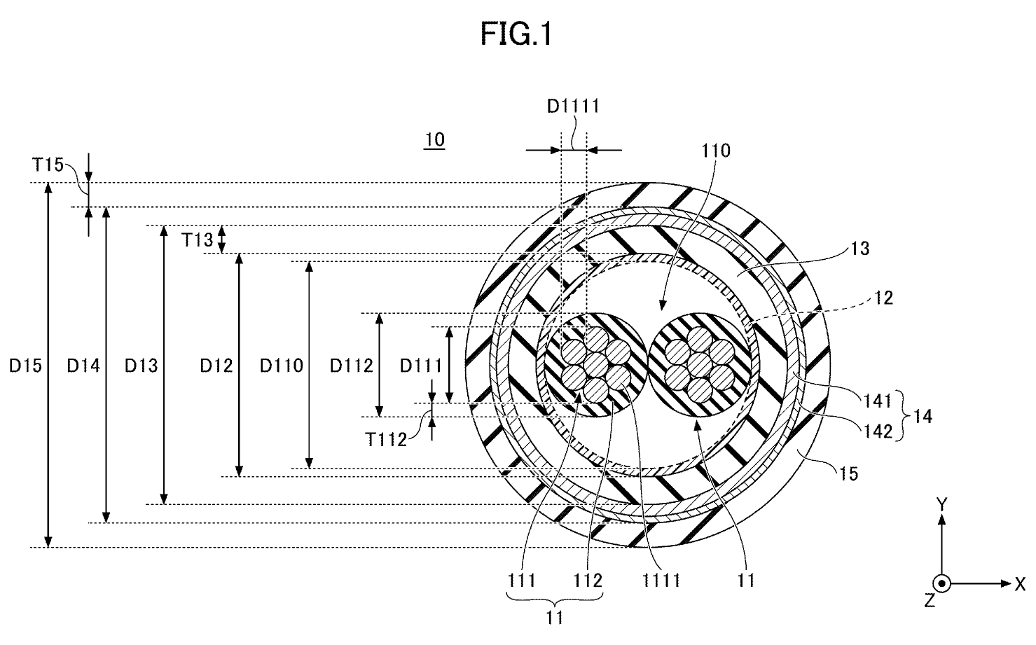

FIGS. 1, 2A, 2B, and 3 are schematic diagrams for explaining the disposition of each component, the procedure of the evaluation method, and the like, and do not accurately indicate the size, shape, and the like of each component.

### Cable

A cross-sectional view perpendicular to the longitudinal direction of a cable 10 of the embodiment is illustrated in FIG. 1.

In FIG. 1, an axis along the longitudinal direction of the cable 10 is defined as a Z-axis, and a plane perpendicular to the longitudinal direction of the cable 10 is defined as an XY plane.

As illustrated in FIG. 1, the cable 10 of the embodiment includes a twisted pair electric wire 110, an inner sheath 13 disposed outside the twisted pair electric wire 110, a shield layer 14 disposed outside the inner sheath 13, and an outer sheath 15 disposed outside the shield layer 14.

Hereinafter, each component of the cable 10 of the embodiment will be described.

### 1. Components of Cable

### 1-1. Twisted Pair Electric Wire

The twisted pair electric wire 110 is formed by twisting a pair of electric wires 11, that is, two electric wires 11. By twisting the pair of electric wires 11 to form the twisted pair electric wire 110, the flexibility of the cable 10 can be enhanced.

### 1-1-1. Electric Wire

The electric wire 11 includes a conductor 111 and an insulator 112 disposed outside the conductor 111.

### Conductor

The configuration of the conductor 111 may be any of a single wire which is one conductive wire, a twisted wire obtained by twisting a plurality of conductor element wires 1111, and a compressed conductor obtained by compressing a twisted wire. When the conductor 111 is a twisted wire obtained by twisting the conductor element wires 1111, the flexibility of the electric wire 11, the twisted pair electric wire 110, and the cable 10 can be enhanced.

As the material of the conductor 111, for example, one or more conductor materials selected from copper, a copper alloy, silver-plated copper, and tin-plated copper may be used. Annealed copper may be used as the copper. The silver-plated copper or the tin-plated copper may be silver-plated annealed copper or tin-plated annealed copper.

The cross-sectional area of the conductor 111 may be, for example, 0.05 mm² to 3 mm².

When the conductor 111 is a twisted wire, the cross-sectional area of the conductor 111 can be obtained from an element wire diameter D1111 of the measured conductor element wire 1111 and the number of conductor element wires 1111. Further, when the conductor 111 is a single wire, the cross-sectional area of the conductor 111 can be obtained from the measured outer diameter of the conductor 111.

### Insulator

The insulator 112 can be disposed outside the conductor 111 as illustrated in FIG. 1, and can cover the outer surface of the conductor 111 along the longitudinal direction.

The insulator 112 may contain a polyolefin resin.

Examples of the polyolefin resin include polyethylene (PE), polypropylene (PP), ethylene-vinyl acetate copolymer (EVA), ethylene-acrylic acid ester copolymer such as ethylene-ethyl acrylate copolymer (EEA), ethylene α-olefin copolymer, ethylene-methyl acrylate copolymer, ethylene-butyl acrylate copolymer, ethylene-methyl methacrylate copolymer, ethylene-acrylic acid copolymer, partially saponified EVA, maleic anhydride modified polyolefin, ethylene-acrylic acid ester-maleic anhydride copolymer, and the like.

As the polyethylene, linear low-density polyethylene (LLDPE), very low-density polyethylene (VLDPE), or the like may be used.

The insulator 112 of the electric wire 11 may contain polypropylene as a main component.

When the insulator 112 contains polypropylene as a main component, the heat resistance of the electric wire 11, the twisted pair electric wire 110, and the cable 10 can be enhanced, and the electric characteristics can be enhanced even when heated.

The cable of the embodiment can be used as a signal line for transmitting a signal at a communication rate of 1 Gbps or higher, for example. Thus, the electrical characteristics in the present specification mainly indicate transmission characteristics when a signal is transmitted, and may be one or more types of characteristics selected from impedance, insertion loss (IL), return loss (RL), longitudinal conversion loss (LCL), and longitudinal transfer conversion loss (LCTL).

IL is an abbreviation for insertion loss. RL is an abbreviation for return loss. LCL is an abbreviation for longitudinal conversion loss. LCTL is an abbreviation for longitudinal conversion transfer loss.

In the present specification, the phrase "heat resistance can be enhanced and electrical characteristics can be enhanced even when heated" indicates that when a test is performed at 105°C based on J3117-2 of the SAE standard, the test is passed. SAE is an abbreviation for Society of Automotive Engineers.

In the present specification, the term “main component” indicates a component having a content of 40% by mass or more in the resin (excluding an additive such as a flame retardant). As the main component, two or more types of components may be contained.

The resin of the insulator 112 can be either crosslinked or non-crosslinked. The resin of the insulator 112 is not necessarily crosslinked, and the electrical characteristics of the electric wire 11, the twisted pair electric wire 110, and the cable 10 can be enhanced by making the resin of the insulator 112 non-crosslinked.

The insulator 112 may contain an additive, such as a flame retardant, a flame retardant aid, an antioxidant, a lubricant, a colorant, a reflection imparting agent, an opacifying agent, a processing stabilizer, and a plasticizer, in addition to the above resin.

### 1-2. Inner Sheath

The cable 10 of the embodiment may include the inner sheath 13 disposed outside the twisted pair electric wire 110.

The inner sheath 13 is disposed outside the twisted pair electric wire 110, so that the shape of the twisted pair electric wire 110 can be stabilized and protected.

The inner sheath 13 may contain a polyolefin resin. Examples of the polyolefin resin have been described in the insulator 112, and thus the description thereof will be omitted.

The inner sheath 13 may contain polypropylene as a main component.

The inner sheath 13 contains polypropylene as a main component, and thus the heat resistance of the cable 10 can be enhanced, and the electrical characteristics can remain high even when the cable 10 is heated.

The inner sheath 13 may further contain thermoplastic elastomer, and may contain the thermoplastic elastomer as a main component.

The inner sheath 13 contains the thermoplastic elastomer, and thus it is possible to enhance the flexibility of the inner sheath 13 and the cable 10. Thus, the repulsive force of the cable 10 can be reduced, and the workability in wiring can be enhanced.

Examples of the thermoplastic elastomer include olefin-based elastomers, polyester-based elastomers, polyurethane-based elastomers, and polyamide-based elastomers. The thermoplastic elastomer may have a melting point of 160°C or higher. By using a thermoplastic elastomer having a melting point of 160°C or higher, the heat resistance of the cable 10 can be enhanced.

The resin of the inner sheath 13 can be either crosslinked or non-crosslinked. The resin of the inner sheath 13 is not necessarily crosslinked, and the electrical characteristics of the cable 10 can be enhanced by making the resin of the inner sheath 13 non-crosslinked.

The inner sheath 13 may contain an additive, such as a flame retardant, a flame retardant aid, an antioxidant, a lubricant, a colorant, a reflection imparting agent, an opacifying agent, a processing stabilizer, and a plasticizer, in addition to the above resin.

### 1-3. Shield Layer

The cable 10 of the embodiment may include the shield layer 14 disposed outside the inner sheath 13.

The cable 10 includes the shield layer 14, and thus it is possible to reduce signal leakage to the outside and radio wave intrusion from the outside. Further, the attenuation amount in the high frequency region of the cable 10 can be reduced.

The shield layer 14 may include a first shield layer 141 including a metal tape and a second shield layer 142 including a metal wire.

Since the cable 10 includes the first shield layer 141 and the second shield layer 142 as the shield layer 14, it is possible to particularly reduce signal leakage to the outside and radio wave intrusion from the outside. Further, the attenuation amount in the high frequency region of the cable 10 can be reduced.

Each shield layer will be described.

### 1-3-1. First Shield Layer

The first shield layer 141 is a layer in which a metal tape is disposed outside the inner sheath 13, and can include a metal tape.

The metal tape may be disposed to be in a longitudinal manner (lengthwise wrapping) or may be disposed in a spiral shape along the longitudinal direction of the inner sheath 13.

“Longitudinal manner” refers to disposing the metal tape so that its length runs along the length of the inner sheath 13 and winding it so that its width follows the outer circumference of the inner sheath 13. When the metal tape is disposed to be in the longitudinal manner, the edge portions along the width of the metal tape may overlap one another.

When the metal tape is disposed in a spiral shape along the longitudinal direction of the inner sheath 13, the metal tape may be disposed in a spiral shape (lateral winding) outside the inner sheath 13 so that at least portions of the metal tape overlap.

By disposing the metal tape outside the inner sheath 13 so that at least portions of the metal tape overlap, the outer surface of the inner sheath 13 can be covered with the metal tape without a gap, thereby enhancing the shielding characteristics.

The metal tape of the first shield layer 141 may include a metal layer including a metal material. Examples of the metal material include one or more selected from copper, a copper alloy, aluminum, an aluminum alloy, and the like. The metal layer of the metal tape may include only one layer of a single metal material, or two or more metal materials may be laminated. Further, a material other than metal, such as a protective film containing an organic material, may be disposed on the surface of the metal layer.

The metal tape may further include a base material. The material of the base material may include an insulating material, such as an organic polymer material or a nonwoven fabric. Examples of the organic polymer material include polyester resins such as polyethylene terephthalate (PET), polyolefin resins such as polypropylene, and vinyl resins such as polyvinyl chloride.

When the metal tape includes the base material, the metal layer may be disposed on one or more surfaces selected from the upper surface and the lower surface of the base material.

### 1-3-2. Second Shield Layer

The second shield layer 142 is a layer including a metal strand.

As a material of the metal strand, for example, a metal material, such as copper, a copper alloy, aluminum, or an aluminum alloy, or a material obtained by plating the surface of the metal material, such as tin-plated annealed copper or silver-plated annealed copper, may be used. Annealed copper may be used as the copper.

The plurality of metal strands in the second shield layer 142 may form a helically wound shield (spiral-wound shield) or may form a braided shield.

As described above, the second shield layer 142 may form the braided shield. By forming the second shield layer 142 as the braided shield, the gaps between the metal strands can be reduced, and thus the radio wave shielding properties of the shield layer 14 can be enhanced. Further, by forming the second shield layer 142 as the braided shield, damage to the second shield layer 142 is reduced even when the cable 10 is repeatedly bent, and durability is enhanced.

### 1-4. Outer Sheath

The outer sheath 15 may be disposed outside the shield layer 14.

The cable 10 of the embodiment includes the outer sheath 15, which protects the shield layer 14 and the twisted pair electric wires 110, thus reducing the damage or the like.

The outer sheath 15 may include a resin material.

Examples of the resin material include one or more selected from polyolefin resins, polyester resins, polyvinyl chloride resins (PVC), fluororesins, and the like.

Examples of the polyolefin resin have been described in the insulator 112, and thus the description thereof will be omitted.

Examples of the polyester resin include polyethylene terephthalate (PET).

Examples of the fluororesin include polytetrafluoroethylene (PTFE), tetrafluoroethylene-perfluoroalkyl vinyl ether copolymer (PFA), tetrafluoroethylene-hexafluoropropylene copolymer (FEP), and ethylene-tetrafluoroethylene copolymer (ETFE).

The resin material of the outer sheath 15 can be either crosslinked or non-crosslinked.

As described above, the resin material of the outer sheath 15 is not necessarily crosslinked. By making the resin material of the outer sheath 15 non-crosslinked, the resin material of the inner sheath 13 can also be made non-crosslinked, and thus the electrical characteristics of the electric wire 11, the twisted pair electric wire 110, and the cable 10 can be enhanced.

The outer sheath 15 may contain an additive, such as a flame retardant, a flame retardant aid, an antioxidant, a lubricant, a colorant, a reflection imparting agent, an opacifying agent, a processing stabilizer, and a plasticizer, in addition to the resin material.

The outer sheath 15 may be formed by, for example, winding a resin tape containing a resin material around the surface of the shield layer 14 in a spiral shape, or may be formed by extrusion molding or the like.

### 1-5. Resin Tape Layer

The cable 10 of the embodiment may further include a resin tape layer 12 including a resin tape disposed in a spiral shape along a longitudinal direction of the twisted pair electric wire 110.

The resin tape layer 12 may, for example, be disposed between the twisted pair electric wire 110 and the inner sheath 13.

The resin tape contained in the resin tape layer 12 may contain a resin material.

Examples of the resin material include one or more selected from polyolefin resins, polyester resins, polyvinyl chloride resins, fluororesins, and the like. Examples of the polyolefin resin, the polyester resin, the polyvinyl chloride resin, and the fluororesin are described in the insulator 112 and the outer sheath 15, and thus the description thereof will be omitted.

The cable 10 of the embodiment further includes the resin tape layer 12, and thus, the shape of the twisted pair electric wire 110 can be stabilized. Thus, in the cable 10 of the embodiment, the shapes of the inner sheath 13, the shield layer 14, and the outer sheath 15 disposed outside the twisted pair electric wire 110 can be stabilized, and can be easily formed into a desired shape.

### 2. Characteristics of Cable

The evaluation methods of the repulsive force and pull-out force described below will be detailed in the examples.

### 2-1. Repulsive Force

In the cable 10 of the embodiment, the repulsive force when the cable 10 is bent into a U-shape and the radius of curvature of the bent portion of the cable 10 is changed from 100 mm to 50 mm may be 0.5 N or less, or may be 0.4 N or less.

When the cable 10 is bent to have a U-shape, the repulsive force becomes stronger as the radius of curvature at the bent portion becomes smaller. By setting the repulsive force to 0.5 N or less when the radius of curvature in the bent portion is changed from 100 mm to 50 mm, the cable is easily deformed and has excellent flexibility, and the workability and the productivity in wiring can be enhanced.

In the cable 10 of the embodiment, the lower limit value of the repulsive force may be, for example, 0.05 N or more, or may be 0.1 N or more. By setting the repulsive force to be 0.05 N or more, the strength and durability of the cable 10 can be enhanced.

Thus, for the cable 10 of the embodiment, the repulsive force may be 0.05 N to 0.5 N, inclusive, or 0.1 N to 0.4 N, inclusive.

The repulsive force of the cable 10 can be set within a desired range by selecting the resin material of the inner sheath 13 and the composition thereof, for example.

### 2-2. Pull-out Force

In the cable 10 of the embodiment, when the shield layer 14 includes the first shield layer 141 and the second shield layer 142, the pull-out force between the first shield layer 141 and the second shield layer 142 may be 10 N or more, or may be 20 N or more.

By setting the pull-out force between the first shield layer 141 and the second shield layer 142 to 10 N or more, the adhesion strength of the shield layer 14 can be enhanced, which allows the cable 10 to prevent damage when force is applied along its longitudinal direction.

The pull-out force between the first shield layer 141 and the second shield layer 142 may be 80 N or less, or may be 60 N or less.

By setting the pull-out force between the first shield layer 141 and the second shield layer 142 to be 80 N or less, the flexibility of the cable 10 can be particularly enhanced.

Thus, in the cable 10 of the embodiment, the pull-out force between the first shield layer 141 and the second shield layer 142 may be 10 N to 80 N, inclusive, or may be 20 N to 60 N, inclusive.

### 2-3. Tensile Modulus

In the cable 10 of the embodiment, the tensile modulus of the inner sheath 13 may be larger than the tensile modulus of the outer sheath 15 and smaller than the tensile modulus of the insulator 112 of the electric wire 11. The tensile modulus of the outer sheath 15 may be less than or equal to half the tensile modulus of the inner sheath 13, and the tensile modulus of the inner sheath 13 may be less than or equal to half the tensile modulus of the insulator 112.

Regarding the outer sheath 15, the inner sheath 13, and the insulator 112, as the distance between the component and the center of the cable 10 decreases, the tensile modulus may increase.

When a force is applied to the cable 10 from the outside, the component far from the center deforms first. Accordingly, by making the tensile modulus smallest in the outer sheath 15 and larger in the inner sheath 13 and the insulator 112 in this order from the center of the cable 10, it is possible to obtain a cable that is particularly easy to deform and has excellent flexibility.

In the present specification, the tensile modulus indicates a tensile modulus measured within a range of 23°C ± 2°C.

### EXAMPLES

Specific examples will be provided and explained below, but the present invention is not limited to these examples.

### 1. Evaluation Method

First, an explanation will be given of a method for evaluating cables manufactured in the following experimental examples.

(1-1) Element wire diameter of conductor element wire, outer diameter of conductor, outer diameter of insulator, outer diameter of resin tape layer, outer diameter of inner sheath, outer diameter of shield layer, outer diameter of outer sheath, thickness of insulator, thickness of inner sheath, thickness of outer sheath

The element wire diameter and the outer diameter of each part were measured using a micrometer or a caliper by the method described in JIS C 3005 (2014).

Specifically, the element wire diameter D1111 of the conductor element wire 1111, an outer diameter D111 of the conductor 111, an outer diameter D112 of the insulator 112, an outer diameter D110 of the twisted pair electric wire 110, an outer diameter D12 of the resin tape layer, an outer diameter D13 of the inner sheath 13, an outer diameter D14 of the shield layer 14, and an outer diameter D15 of the outer sheath 15 were measured.

To describe the measurement method by taking the case of the conductor 111 as an example, on a cross-section perpendicular to the longitudinal direction of the cable 10, two mutually orthogonal diameters of the conductor 111 were measured, and the arithmetic average value was defined as the outer diameter D111 of the conductor 111. The element wire diameter and the outer diameter of the parts were measured under the same conditions and in the same procedure except that the measurement target was changed to the conductor element wire 1111, the insulator 112, the twisted pair electric wire 110, the resin tape layer 12, the inner sheath 13, the shield layer 14, and the outer sheath 15.

The thickness T112 of the insulator 112 was calculated by subtracting the outer diameter D111 of the conductor 111 from the outer diameter D112 of the insulator 112 and dividing the result by 2. That is, the value was calculated by T112 = (D112 - D111) ÷ 2.

The thickness T13 of the inner sheath 13 was calculated by subtracting the outer diameter D12 of the resin tape layer 12 from the outer diameter D13 of the inner sheath 13 and dividing the result by 2.

The thickness T15 of the outer sheath 15 was calculated by subtracting the outer diameter D14 of the shield layer 14 from the outer diameter D15 of the outer sheath 15 and dividing the result by 2.

### 1-2. Cross-sectional Area of Inner Sheath, Cross-sectional Area of Outer Sheath

The cross-sectional area of the inner sheath 13 was calculated from the measured and calculated outer diameter D13 of the inner sheath 13 and the outer diameter D12 of the resin tape layer 12, assuming that the cross-sectional shapes of the inner sheath 13 and the resin tape layer 12 were circles. Specifically, the cross-sectional area of the inner sheath 13 was obtained by subtracting the area of the circle calculated from the outer diameter D12 of the resin tape layer 12 from the area of the circle calculated from the outer diameter D13 of the inner sheath 13.

The cross-sectional area of the outer sheath 15 was calculated from the outer diameter D15 of the outer sheath 15 and the outer diameter D14 of the shield layer 14, assuming that the cross-sectional shapes of the outer sheath 15 and the shield layer 14 were circles. Specifically, the cross-sectional area of the outer sheath 15 was obtained by subtracting the area of the circle calculated from the outer diameter D14 of the shield layer 14 from the area of the circle calculated from the outer diameter D15 of the outer sheath 15.

### 1-2. Twist Pitch, Pitch

The twist pitch of the twisted pair electric wire, the twist pitch of the second shield layer, and the pitch of the resin tape layer were measured based on JIS C 3005 (2014).

### 1-3. Tensile Modulus

The insulator 112, the inner sheath 13, and the outer sheath 15 of the electric wire 11 were subjected to a tensile test in accordance with JIS K 7161 (2024) using a tensile tester at a tensile speed of 500 mm/min and a gauge length of 50 mm.

### 1-4. Repulsive Force

The repulsive force was evaluated according to the IEC60794-1-2 Method 17c.

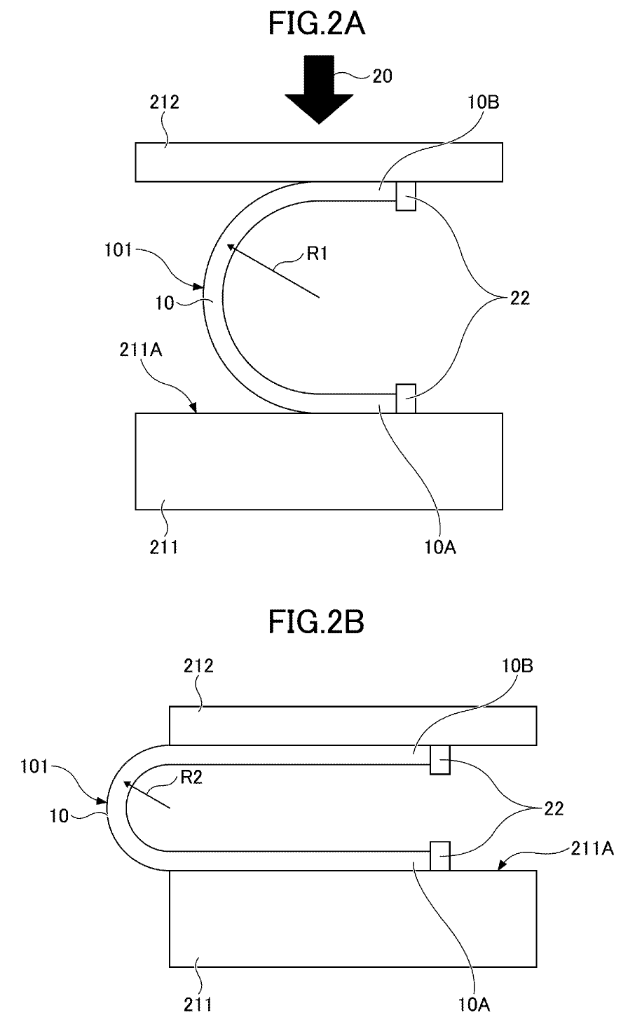

In the evaluation of the repulsive force, as illustrated in FIG. 2A, a first end portion 10A of the cable 10 along the longitudinal direction was fixed with a fixing member 22 on a fixing surface 211A of a first fixing plate 211. Then, the cable 10 was bent at a bent portion 101 into a U-shape, and a second end portion 10B along the longitudinal direction of the cable 10 was fixed to the fixing member 22 of a second fixing plate 212. The fixing surface 211A of the first fixing plate 211 and the second fixing plate 212 were arranged to be parallel to each other.

Then, a load is applied along a block arrow 20 at a speed of 100 mm/min from the state where a radius of curvature R1 at the bent portion 101 illustrated in FIG. 2A is 100 mm until the state where a radius of curvature R2 at the bent portion 101 illustrated in FIG. 2B is 50 mm, and the cable 10 is deformed. The load applied during this time was measured by load cells (not illustrated) installed on the second fixing plate 212, and the maximum load from the 100 mm state to the 50 mm state was taken as the repulsive force.

### 1-5. Pull-out Force

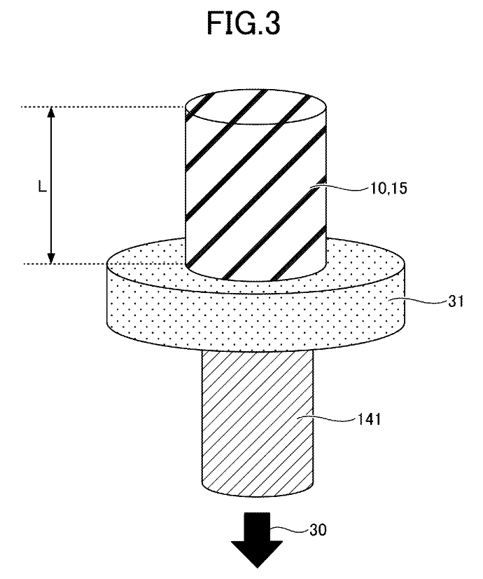

As illustrated in FIG. 3, the pull-out force was measured using a pull-out force measurement jig 31 provided with a through-hole having a size and a shape through which only the components inside the second shield layer 142, that is, the first shield layer 141, the inner sheath 13, the resin tape layer 12, and the twisted pair electric wire 110 pass.

First, the outer sheath 15 and the second shield layer 142 of the cable 10 were removed except for a part thereof. At this time, as illustrated in FIG. 3, the outer sheath 15 and the second shield layer 142 were left so that a length L of the outer sheath 15 and the second shield layer 142 (not illustrated) along the longitudinal direction of the cable 10 was 50 mm. In FIG. 3, the cross-sectional structure of the cable 10 seen at the upper end is omitted.

Then, the exposed first shield layer 141 was inserted into the through-hole of the pull-out force measurement jig 31. As a result, as shown in FIG. 3, the cable 10 is set on the pull-out force measurement jig 31.

Then, the cable 10 was pulled at a speed of 250 mm/min along a block arrow 30 in a state where the pull-out force measurement jig 31 was fixed. Then, the outer sheath 15 and the second shield layer 142, which were partially remaining, were peeled off from the cable 10, and the magnitude of the force applied when the components inside the second shield layer 142 passed through the through-hole of the pull-out force measurement jig 31 and moved to the lower side of the pull-out force measurement jig 31 was measured. The magnitude of the measured force was defined as the pull-out force.

### 1-6. Electrical Characteristics

The evaluation was performed according to SAE standard J3117-2 at a heat resistance class of 105°C.

When all of the impedance, the insertion loss (IL), the return loss (RL), the longitudinal conversion loss (LCL), and the longitudinal transmission conversion loss (LCTL) met the criteria, the result was evaluated as A, and if any one failed, it was evaluated as B.

The case where the evaluation is A indicates that the electrical characteristics are excellent even after the heat resistance test in which heating at 105°C is performed.

### 2. Experimental Conditions and Results

The cables in the respective experimental examples will be described below.

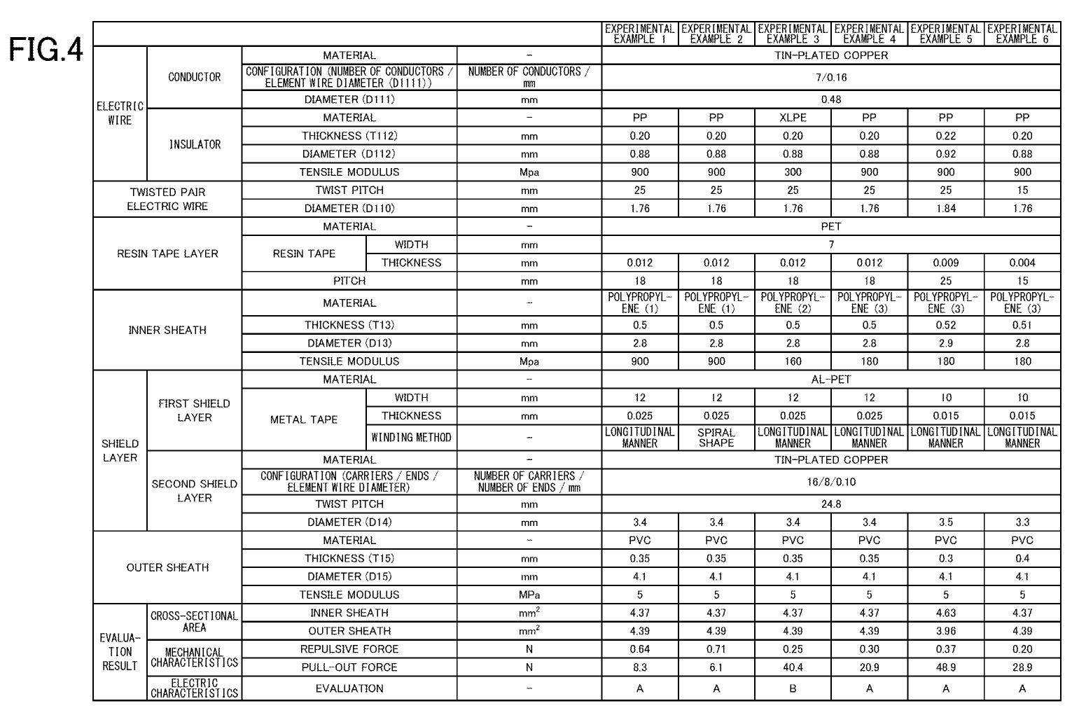

Cables of Experimental Example 1, Experimental Example 2, Experimental Example 3, Experimental Example 4, Experimental Example 5, and Experimental Example 6 were produced under the conditions shown in FIG. 4, and evaluation was performed. Experimental Examples 1 and 2 are comparative examples, and Experimental Examples 3, 4, 5, and 6 are the embodiments.

In FIG. 4, "PP" indicates polypropylene, "PET" indicates polyethylene terephthalate, "AL-PET" indicates a metal tape in which a metal layer of aluminum is disposed on a base material of polyethylene terephthalate, and "PVC" indicates a polyvinyl chloride resin.

### 2-1. Experimental Example 1

The cable 10 having the cross-sectional shape illustrated in FIG. 1 and the material and configuration indicated in FIG. 4 was produced. The resin tape layer 12 is formed by winding a resin tape having a width and a thickness indicated in FIG. 4 in a spiral shape along the longitudinal direction of the twisted pair electric wire 110. Unlike "polypropylene (2)" and "polypropylene (3)" described later, "polypropylene (1)", which is the material of the inner sheath 13, contains only polypropylene as a main component as a resin material, and does not contain thermoplastic elastomer. The resins of the insulator 112, the resin tape layer 12, the inner sheath 13, and the outer sheath 15 are not crosslinked. The results of the evaluation are indicated in FIG. 4.

### 2-2. Experimental Example 2

The cable 10 was produced and evaluated under the same conditions as in Experimental Example 1 except that the metal tape of the first shield layer was wound in a spiral shape along the longitudinal direction of the inner sheath 13. The results of the evaluation are indicated in FIG. 4.

### 2-3. Experimental Example 3

The resin material of the insulator 112 of the electric wire 11 was XLPE, that is, crosslinked polyethylene. As the material of the inner sheath 13, "polypropylene (2)" was used instead of "polypropylene (1)". Except for the above, the cable 10 was produced under the same conditions as in Experimental Example 1, and the evaluation was performed. The results of the evaluation are indicated in FIG. 4.

The material of the inner sheath 13, "polypropylene (2)", contains polypropylene and thermoplastic elastomer as main components.

### 2-4. Experimental Example 4

As the material of the inner sheath 13, "polypropylene (3)" was used instead of "polypropylene (1)". Except for the above, the cable 10 was produced under the same conditions as in Experimental Example 1, and the evaluation was performed. The results of the evaluation are indicated in FIG. 4.

The material of the inner sheath 13, "polypropylene (3)", contains polypropylene and thermoplastic elastomer as main components.

### 2-5. Experimental Example 5 and Experimental Example 6

As indicated in FIG. 4, in Experimental Example 5, the thickness T112 of the insulator 112, the thickness and pitch of the resin tape used for the resin tape layer 12, the thickness T13 of the inner sheath 13, the width and thickness of the metal tape used for the first shield layer 141, and the thickness T15 of the outer sheath 15 were changed.

In Experimental Example 6, the twist pitch of the twisted pair electric wire 110, the thickness and pitch of the resin tape used for the resin tape layer 12, the thickness T13 of the inner sheath 13, the width and thickness of the metal tape used for the first shield layer 141, and the thickness T15 of the outer sheath 15 were changed.

Except for the above, the cable 10 was produced under the same conditions as in Experimental Example4, and the evaluation was performed. The results of the evaluation are indicated in FIG. 4.

According to the results shown in FIG. 4, it was confirmed that the cables of Experimental Examples 3, 4, 5, and6 had a repulsive force of 0.5 N or less, and thus were cables having excellent flexibility.

Further, it has been confirmed that the cables in Experimental Examples3, 4, 5, and 6 have a pull-out force of 10 N or more, preventing damage even when force is applied along the longitudinal direction of the cable.

Furthermore, the cables of Experimental Examples4, 5, and 6 also had an “A” in the evaluation of the electrical characteristics, and demonstrated excellent heat resistance, maintaining high electrical characteristics even when heated.

What is claimed is:

1. A cable comprising:
a twisted pair electric wire in which a pair of electric wires are twisted;
an inner sheath disposed outside the twisted pair electric wire;
a shield layer disposed outside the inner sheath; and
an outer sheath disposed outside the shield layer,
wherein a repulsive force when the cable is bent in a U-shape and a radius of curvature of a bent portion of the cable is changed from 100 mm to 50 mm is 0.5 N or less.

2. The cable according to claim 1, wherein a tensile modulus of the inner sheath is larger than a tensile modulus of the outer sheath and smaller than a tensile modulus of an insulator included in the electric wires.

3. The cable according to claim 1, wherein the inner sheath contains polypropylene as a main component.

4. The cable according to claim 3, wherein the inner sheath further contains a thermoplastic elastomer as the main component.

5. The cable according to claim 1, wherein an insulator included in the electric wires contains polypropylene as a main component.

6. The cable according to claim 1,
wherein the shield layer includes a first shield layer including a metal tape, and a second shield layer including a metal wire, and
wherein a pull-out force between the first shield layer and the second shield layer is 10 N or more.

7. The cable according to claim 1, further comprising a resin tape layer in which a resin tape is disposed in a spiral shape along a longitudinal direction of the twisted pair electric wire.
